(19) United States
(12) Patent Application Publication
(10) Pub. No.: US 2025/0067002 A1
(43) Pub. Date: Feb. 27, 2025

(54) PREPARATION OF A FOAM COMPRISING DISCRETE UNITS OF FOAM EMBEDDED IN A FOAM MATRIX

(71) Applicant: Stora Enso OYJ, Helsinki (FI)

(72) Inventors: Oruç Köklükaya, Stockholm (SE); Daniel Hult Torron, Täby (SE); Maryam Ghanadpour, Solna (SE); Martin Sterner, Farsta (SE)

(73) Assignee: Stora Enso OYJ, Helsinki (FI)

(21) Appl. No.: 18/722,213

(22) PCT Filed: Dec. 22, 2022
(86) PCT No.: PCT/IB2022/062666

§ 371 Date: Jun. 20, 2024

(30) Foreign Application Priority Data
Dec. 22, 2021 (SE) 2151607-5
Sep. 23, 2022 (SE) 2230300-2
Sep. 23, 2022 (SE) 2230301-0
Sep. 23, 2022 (SE) 2230310-1

(51) Int. Cl. D21J 7/00; D21F 11/00; D21J 1/02; D21J 1/06; D21J 1/08

(52) U.S. Cl. CPC D21J 7/00; D21F 11/002; D21J 1/02; D21J 1/06; D21J 1/08

(57) ABSTRACT

The present invention relates to a method for the preparation of a solid foam, wherein the method comprises depositing discrete units of a foam on a surface to obtain a first foam deposition, followed by depositing a wet foam between the discrete units to obtain a subsequent foam deposition, and drying the wet foam. The invention further relates to a solid foam comprising discrete units of foam embedded in a foam matrix.

### FIELD OF THE INVENTION

The present invention relates to a method for the preparation of a solid foam, wherein the method comprises depositing discrete units of a foam on a surface to obtain a first deposition, followed by depositing a wet foam between the discrete units to obtain a subsequent deposition, and drying the wet foam to obtain a solid foam wherein discrete units of a foam are embedded in a foam matrix. The invention further relates to the solid foam comprising discrete units of foam embedded in a foam matrix.

### TECHNICAL BACKGROUND

Today different techniques are used to deposit wet foam material and produce low-density thick foam materials. In WO2020011587 A1 a porous material of cellulose fibres and gluten is prepared by depositing at once an aerated wet foam of cellulose fibres and gluten in a mould, followed by drying, to obtain a dried porous material with the shape of the mould and a homogeneous fibre network through the whole bulk. In WO2015036659 A1 a wet fibrous foam is fed into a mould, where part of the water contained in the foam is mechanically withdrawn to produce a solidified, moist fibrous composition, and evaporating water to produce a dry fibrous product. These techniques are similar in that the final foam sheet might present a densified layer on the faces of the sheet, while the core of the foam sheet is a homogeneous fibre network of lower density.

Collapse of a particulate or fibrous foam causes the thickness of a foam sheet to shrink, as tension forces pull the particles, or fibres, together. Drying shrinkage is an inherent property of cellulose, as fibres will collapse onto each other when water is removed from the system. Even in more complicated drying systems such as combined air impingement and IR-dryers, shrinkage above 10% is expected.

Similar to conventional papermaking techniques, foam-forming needs to be drained onto a screen. In this case, there are limits to the shape and size of the material as it will level during draining. The density and thickness of the sample is determined by the wet fibrous foam concentration, which is usually from 1-4 wt %, and the amount of draining before drying. Generally dry content is about 1% to 8% after draining. For efficient draining to occur, the viscosity of the suspension needs to be kept rather low for efficient extraction of water. Any soluble binder would be limited to low concentrations and being able to retain on the fibre to avoid excessive losses. Therefore, draining limits the number of additives that could be used in this type of process. The strength of thick low-density foam-formed paper is primarily controlled by the bulk of the material. The primary means of improving strength here is to increase density, with some limited control on fibre orientation, based on draining characteristics.

Higher dry-content techniques such as foams made from large quantities of protein-based foaming-agents, such as in WO2020011587 A1, hinders recyclability due to large fractions of the material not being water soluble or easily washed out from the product. The method also suffers from poor wet-foam stability, as protein particles start to agglomerate and bubbles coalesce, leading to gradual collapse of foam in the wet-state. This fact makes it a non-suitable candidate for free-standing wet foam deposition.

To avoid shrinkage, the foam needs to dry under tension, but when drying a very large surface area the tension obtained by the frame or mould is limited to the regions closest to the mould. Thus, shrinkage is a problem, especially when drying large surface areas. The drying time of the foam is typically long since both the wet foam and dry foam are heat insulating. A short drying time is desired to enable a cost-efficient process. Thus, there is still a need for alternative methods for foam preparation. In addition, the prepared foam should have a high impact resistance when used as a packaging material to enable protection also of heavier objects.

### SUMMARY OF THE INVENTION

It is an object of the present invention to provide a method suitable for the preparation of a foam where the shrinkage of the foam is reduced. The method enables a structural control of thick low-density foam materials, through a controlled wet-deposition technique and is particularly suitable for the preparation of cellulose foam sheets. Preferably, the method also enables a shorter drying time of the foam.

A further object is to provide a lightweight solid foam with good dimensional stability.

To be more specific, this invention relates to cellulose foam materials comprising discrete units of a cellulose foam embedded in a cellulose foam matrix, wherein the cellulose foam material has a low density. The cellulose foam matrix surrounding the discrete units may be composed of the same foam composition as the discrete units. The discrete units may be distinguished from the matrix by a densified layer. Furthermore, this foam material can be made by two or more individual deposition steps with a drying step after each deposition. The method allows for the creation and control of densified cellulose fibre walls. When dry, the fibres can be re-dispersed in water and as a result the foam can be recyclable in regular paper recycling streams.

Thus, this invention pertains both to a cellulose foam having a characteristic macrostructure with discrete units of cellulose foam embedded in a cellulose foam matrix, and the method to obtain the foam, which comprises a multistep deposition and drying method.

The cellulose foams are expected to contribute to technologies in protective packaging as a cushioning material, thermal insulation for cold chain logistics, and as a construction material, acoustic insulation panels, as a hydroponic plant growing media, and other applications that need lightweight, high-performance bio-based materials.

### BRIEF DESCRIPTION OF THE DRAWINGS

FIG. 1A) shows a schematic representation of a prior art foam plank with densification on top and bottom and B) shows a schematic representation of the inner bulk in such foam plank, which comprises a homogeneous fibre network with a lower density through the whole bulk.

FIG. 2 is a schematic representation of cross-section of a comparative foam after drying showing influence of aspect ratio of width to height on shrinkage.

FIG. 3 a) shows a graph obtained from drying of a single large block of a comparative cellulose foam, displaying the dry thickness of the densified layer, i.e. crust, (—) on the left Y-axis, and the shrinkage profile (◯) on the right y-axis, as a function of % conversion of liquid water to steam during drying, and b) illustrates the cross section of two fibres (white circles) in a wet environment (grey area) and during drying. Steps A), B) and C) in FIG. 3b) corresponds to the situation in zone A), B) and C) in FIG. 3a).

FIG. 4 illustrates a two-step deposition with i) a first deposition of cellulose foam as discrete units, ii) an intermittent drying step drying the discrete units to create iii) self-standing discrete units of cellulose foam, iv) a second deposition of cellulose foam between the discrete units of cellulose foam, and v) a second drying step to obtain vi) a cellulose foam material comprising discrete units of cellulose foam.

FIG. 5 shows a schematic representation of a solid foam sheet produced according to the method of the present invention, where A) illustrates the solid foam with a densified layer at the top and at the bottom in black colour, and looking externally similar to foam sheets produced with other techniques, B) illustrates the bulk of the material beneath the densified top and bottom, the bulk containing discrete units of cellulose foam (black cuboids), where each discrete unit is distinguished from the surrounding foam matrix by a densified layer of cellulose, and C) illustrates one discrete unit surrounded by a densified layer of cellulose (left), illustrated in black, and the homogenous cellulose foam inside the densified layers (right).

FIG. 6 illustrates differences in tension development (higher tension in darker area) during drying of (a) single block and (b) multistep deposition.

FIG. 7 shows an example of compression curves showing single-step deposition (lower dashed curve), as prepared according to Example 2, and multistep deposition (upper solid curve), as prepared according to Example 1, for the same density foam (30 kg/m³).

FIGS. 8a-b show the drying times for cellulose foam planks with different sizes of the discrete units, and compared to the drying times for a single step foam deposition. 8a illustrates the drying time for discrete units with varying widths and a height of 2.1 cm. 8b illustrates the drying time for the subsequent wet foam deposition surrounding the discrete units in 8a, the height of the subsequent wet foam deposition is 2.1 cm.

FIGS. 9-11 shows the cushioning performance of a solid foam according to the present invention during impact, measured by drop testing the foam with a load containing an accelerometer on top of the foam. Results of peak acceleration for drop 1 (FIG. 10) and for the average of drops 2-5 (FIG. 11) and degradation, measured as the relative compression after 5 drops (FIG. 9) is shown. Cellulose foam samples composed of discrete units of foam having the same or different density as compared to the cellulose foam matrix are tested; and compared to single step deposited foam samples.

### DETAILED DESCRIPTION OF THE INVENTION

In a first aspect the present invention provides for a method for the preparation of a solid foam, wherein the method comprises depositing discrete units of a foam on a surface to obtain a first foam deposition, depositing a wet foam between the discrete units to obtain a subsequent foam deposition, and drying the wet foam in the subsequent foam deposition to obtain a solid foam wherein discrete units of a foam are embedded in a foam matrix.

The term “foam”, as used herein, refers to a substance made by trapping air or gas bubbles inside a solid or liquid. Typically, the volume of gas is much larger than that of the liquid or solid, with thin films separating gas pockets. Three requirements must be met in order for foam to form. Mechanical work is needed to increase the surface area. This can occur by agitation, dispersing a large volume of gas into a liquid, or injecting a gas into a liquid. The second requirement is that a foam forming agent, typically an amphiphilic substance, a surfactant or surface-active component, must be present to decrease surface tension. Finally, the foam must form more quickly than it breaks down. The foam may be wet or dry, i.e. solid.

The term “discrete unit” as used herein refers to an individual foam unit within a solid foam. The discrete units are deposited as separate units of foam. The space between the discrete units in the solid foam is filled with foam, such that the discrete units are embedded in a foam matrix. The discrete units are distinguishable from each other and from the foam matrix.

In one embodiment, the solid foam is a cellulose foam, and the foam in the discrete units and the foam in the foam matrix are both cellulose foams. The term “cellulose foam” refers to a foam comprising cellulose, and other components such as thickeners, surfactants and additives. The main component of the cellulose foam is cellulose, such that cellulose constitutes at least 70 wt %, or from 75-95 wt %, of the solid content of the cellulose foam. Cellulose is in the form of fibres, and the foam can thus also be defined to be a fibrous foam or a cellulose fibre foam. The cellulose foam may be wet or dry.

The wet foam used in the discrete units may be a fibrous foam. The wet foam used in the discrete units may comprise at least 10 wt % cellulose fibres, or at least 11 wt % cellulose fibres, as calculated on the total weight of the wet foam. The wet foam may comprise 10-40 wt %, 11-40 wt %, 10-30 wt %, 11-30 wt %, 10-20 wt %, or 11-20 wt %, cellulose fibres, as calculated on the total weight of the wet foam. The cellulose fibres may be selected from wood pulp; regenerated cellulose fibres; or plant fibres, such as fibres from bamboo, cotton, hemp, flax, and jute. Preferably, the cellulose fibres are selected from wood pulp, such as softwood kraft bleached pulp, chemical-thermomechanical pulp, dissolving pulp (such as bleached wood pulp or cotton linters), and hardwood pulp; more preferably from softwood kraft bleached pulp and chemical-thermomechanical pulp; and most preferably softwood kraft bleached pulp.

In one embodiment, the discrete units may be made by dispensing a wet foam in discrete units on to a surface followed by drying of the discrete units. The wet foam forming the discrete units may have a density from 70-600 kg/m³, or from 100-500 kg/m³, or from 100-400 kg/m³, or from 125-375 kg/m³, or from 140-375 kg/m³. A large number of small bubbles provides stability to the foam and provides for a low density. The wet foam used in the present method has a sufficiently high viscosity and low density to enable the formation of discrete units that do not collapse before they are dried. Each discrete unit may thus stand by itself without collapsing before being dried. Further, each discrete unit may be self-standing during drying without collapsing. Drying of the discrete units of the wet foam is at least made until a crust, i.e. a thin densified layer of cellulose fibres, is formed on an outer surface of the discrete unit, such as on each of the faces of the discrete unit. The densified layer is a very thin layer that is formed on the very outer surface of the foam during drying. The densified layer is made up of cellulose fibres that are mainly oriented in a two-dimensional plane (x-y-plane), while the fibres in the bulk of the foam comprises clusters of fibres oriented in a three-dimensional space with more empty space in between clusters. The two-dimensional structure of cellulose fibres in the densified layer transitions rapidly, but gradually, to the three-dimensional structure found in the bulk of the foam. The thin thickness of the densified layer implies that it practically does not affect the overall density of the foam, while it still contributes to the good mechanical properties of the discrete units.

Optionally, further foam depositions of discrete units may be made on the surface, preferably between the discrete units of the first deposition. The wet foam forming the discrete units in the further deposition may have a density of from 70-600 kg/m³, or from 100-500 kg/m³, or from 100-400 kg/m³, or from 125-375 kg/m³, or from 140-375 kg/m³. The density of the wet foam used in the further deposition may be the same for the wet foam in the first deposition, or it may be different.

When discrete units of a foam comprising cellulose fibres have been dried, their core consists of a homogeneous fibre network having a density, and their outer surfaces, such as their bottom, top and side faces, consists of a more densely packed fibre network. The formation of a densified layer on the faces of the deposited discrete units in the first foam deposition makes the discrete units stronger and prevents them from being demolished during subsequent foam depositions, when wet foam is deposited between the discrete units. The dried discrete units may have an overall density of from 10-60 kg/m³, or from 20-50 kg/m³. In one embodiment, the dried discrete units may have an overall density of from 10-80 kg/m³.

In an alternative embodiment, the discrete units may be made by extruding or casting a wet foam, drying the wet foam to obtain a dry foam, cutting said dry foam into discrete units, and depositing said discrete units on to a surface. Preferably the wet foam is extruded into a board, plank, bar or rod. The board, plank, bar or rod can be cut into discrete units, which may be deposited on to a surface.

In some embodiments, the discrete units of foam are at least partially dried when the wet foam of the subsequent foam deposition is deposited. In some embodiments, the discrete units of foam are completely dried when the wet foam of the subsequent foam deposition is deposited.

Each discrete unit may have a three-dimensional shape, such as a cylinder, or a polyhedron. Examples of symmetric polyhedrons are cubes, cuboids, and hexagonal prisms. Small variations in the symmetry of the discrete units may exist without changing their main purpose to impart stability to the foam. For example, the cylinder, cube, cuboid, and hexagonal prism may be slightly distorted so that their opposite bases are not always exactly parallel and over each other. In some embodiments, each discrete unit has the shape of a cylinder. The term “cylinder” is used herein for the geometrical figure that is commonly defined as a closed solid with two principally parallel, congruent, and circular or oval, bases that are connected by a curved surface. In some embodiments, each discrete unit has the shape of a cuboid.

Discrete units obtained in further foam depositions may have the same or a different three-dimensional shape as the discrete units obtained in the first deposition.

As used herein, the height of the discrete unit is measured perpendicular to the surface on which the unit has been deposited. As used herein, the width, or average of the length and width, is measured at the bottom part of the discrete unit. The bottom part of the discrete refers to the part of the discrete unit that is closest to the surface on which the discrete unit has been deposited on. For discrete units having a circular shape, the width corresponds to the diameter of the discrete unit. Depending on the shape of the discrete unit, the width of the discrete unit may be the same along the entire height of the discrete unit, or it may be different.

The width of a discrete unit may be from 0.5 to 3 times its height, or from 0.5 to 2, or from 0.5 to 1.5, or from 0.8 to 3, or from 0.8 to 2, or from 0.8 to 1.5, or from 1 to 3, or from 1 to 2, or from 1 to 1.5 times its height.

In some embodiments, the width of a discrete unit is less than 1.3 times its height, such as less than 1.2, or from 0.5 to 1.3, or from 0.5 to 1.2, or from 0.7 to 1.3, or from 0.7 to 1.2, or from 0.9 to 1.3, or from 0.9 to 1.2 times its height. The total drying time of the wet foam to a solid foam is shortened when the width of the discrete units is less than 1.3 times its height.

The term “total drying time” as used herein, refers to the total time it takes for the foam to dry, i.e. the sum of the drying time for the discrete units and the drying time for the foam matrix.

In some embodiments, the width of the discrete units is larger at the bottom part of the discrete units than at the top part. For example, the discrete units may have the shape of a cone, a truncated cone, a pyramid, or a truncated pyramid. In some embodiments, each discrete unit has the shape of a pyramid.

In some embodiments where the width of the discrete units is larger at the bottom part of the discrete unit than at the top part of the discrete unit, the bottom parts of adjacent discrete units may be partly in contact with each other. The contact may be along the entire perimeter, or along parts of the perimeter, of the bottom parts of the discrete units. For the remaining height, i.e. the part of the height of the discrete unit located above the bottom part, the discrete units are separated from each other, i.e. not in contact. For example, a discrete unit may be partly in contact with one or several adjacent discrete units along less than 30%, or less than 20%, or less than 10%, or less than 5%, of the height of a discrete unit, as measured perpendicular from the surface on which the discrete unit has been deposited. The discrete units are deposited as separate units, however the size and shape of the discrete units depend on the deposition technique. The bottom part of the deposited discrete units may be made to flow outwards, given a large enough shear stress is applied so as to overcome the yield stress of the wet foam in the discrete unit. The bottom parts of adjacent discrete units may thus come into contact with each other. Also in embodiments where the discrete units are partly in contact, the discrete units are distinguishable from each other, both before and after drying. No mixing will occur between wet foams from different discrete units at places of contact.

A subsequent deposition of wet foam is made between the already dried discrete units. The height of the wet foam in this subsequent deposition may be slightly higher or equal to the height of the discrete units. In some embodiments, after said deposition of foam between the discrete units, the height of the discrete units may be from 90 to 100%, or from 95 to 100%, or from 98 to 100%, of the height of the foam matrix surrounding said discrete units.

In some embodiments, the height of the discrete units may be from 70 to 100%, or from 70 to 95%, or from 75 to 90%, of the height of the foam matrix surrounding said discrete units. In embodiments where the height of the discrete units is lower than that of the surrounding foam matrix, a smooth top surface of the solid foam is obtained. In such embodiments, the discrete units are not visible from the top surface of the solid foam since they are covered by the foam matrix.

In some embodiments a deposition of wet foam may also be made on top of the discrete units, either simultaneously with the previously mentioned deposition of the wet foam between the discrete units or in a successive deposition. The surface of the subsequent deposition of wet foam may be scraped before drying to provide an even surface.

The wet foam in the subsequent deposition may be a fibrous foam. The wet foam may comprise at least 10 wt % cellulose fibres, or at least 11 wt % cellulose fibres, as calculated on the total weight of the wet foam. The wet foam may comprise 10-40 wt %, 11-40 wt %, 10-30 wt %, 11-30 wt %, 12-30 wt %, 10-20 wt %, or 11-20 wt %, or 12-20 wt % cellulose fibres, as calculated on the total weight of the wet foam.

The cellulose fibres used in the subsequent deposition are suitably selected from different kinds of wood pulp; regenerated cellulose fibres; or plant fibres, such as fibres from bamboo, cotton, hemp, flax, and jute. Preferably, the cellulose fibres are selected from wood pulp, such as from softwood kraft bleached pulp, chemical-thermomechanical pulp (CTMP), dissolving pulp (such as bleached wood pulp or cotton linters), and hardwood pulp; more preferably from softwood kraft bleached pulp and chemical-thermomechanical pulp; and most preferably softwood kraft bleached fibres. The cellulose fibres used in the subsequent deposition may be of the same sort as the cellulose fibres used in the discrete units of earlier depositions, i.e. the first and optionally further depositions.

The wet foam used in the subsequent deposition may have a density from 70-600 kg/m³, or from 100-500 kg/m³, or from 100-400 kg/m³, or from 125-375 kg/m³, or from 140-375 kg/m³. The solid foam prepared with the method according to the present invention may have a density of 10-60 kg/m³, or from 20-50 kg/m³. In one embodiment, the solid foam prepared with the method according to the present invention may have a density of 10-80 kg/m³.

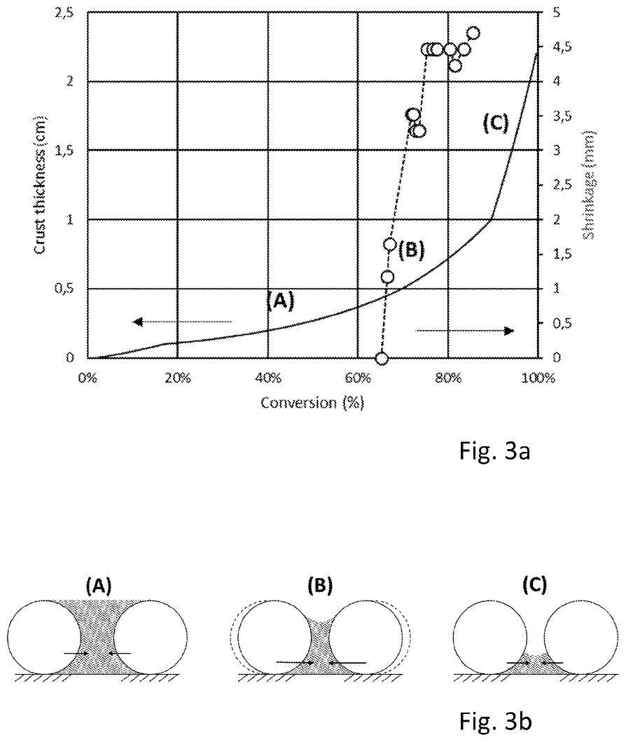

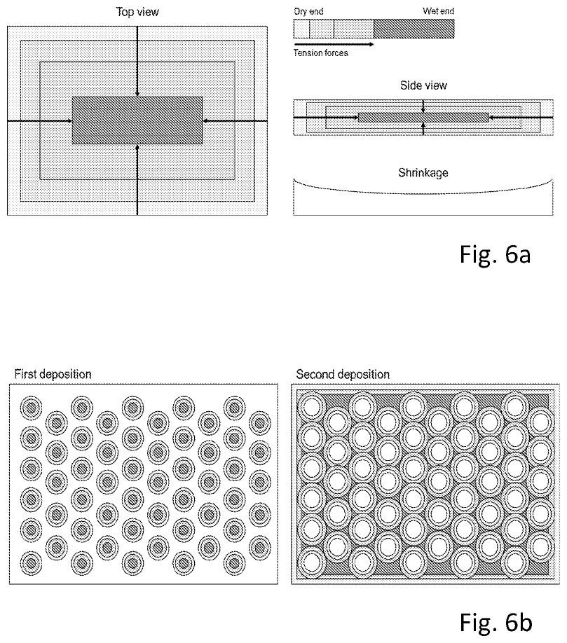

In a wet foam, resistance forces keep the cellulose fibres in place (illustrated in FIG. 3b, A). During drying, the water level between the fibres recedes causing capillary forces to build up inside the foam material, and when the capillary forces exceed the resistance forces, the fibres slip (FIG. 3b, B). As water evaporates, the resistance forces increase and causes the fibres to get stuck in a position closer to each other than before drying, which causes the material to shrink (FIG. 3b, C). On a macroscopic level, the geometry of the foam influences the direction and magnitude of tension vectors that build up in the material during drying. Points of contact, such as a frame or a perforated surface, causes tension in the opposite direction and will impact the net tension forces. Deformation, such as shrinkage, will occur when the net tension forces, i.e. the tension vector, dominate in any particular direction which is illustrated for a comparative foam without discrete units in FIG. 2 and FIG. 6a. Thus, the ratio of the width, or surface area, to the height of cellulose foam planks affects the distribution of the net tension forces in a foam material upon drying, and the greater the ratio, the greater the net tension forces that arise.

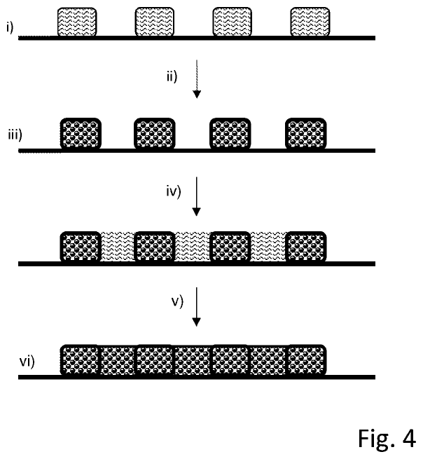

Preparation of a foamed material according to the method of the present invention reduces the net tension forces arising in the material upon drying and the shrinkage of the material may thus be mitigated. FIG. 4 illustrates one embodiment of the method of the present invention, wherein a wet fibrous foam is deposited on a surface as small discrete units to obtain a first deposition (i). Each discrete unit has a low aspect ratio of width to height, which eliminates or significantly reduces shrinkage of each discrete unit when the units are dried (ii). When the discrete units are dried, they will consist of a core comprising a homogeneous fibre network, and densified outer faces (i.e. the top, bottom and sides) (iii). A subsequent deposition of a wet foam is then made on the surface between the already dried discrete units (iv). When the wet foam of the subsequent deposition is being dried (v) the discrete units of the first deposition that are already distributed on the surface provides for a low width to height ratio of the wet foam in the subsequent deposition. The tension forces of each discrete unit will act against each other thus reducing the net tension forces in the foam of the subsequent deposition, which restrains build-up of the tension during drying and as a result mitigates the effect of shrinkage on the outer dimensions of the obtained solid foam (vi). The method of the present invention thus provides for formation of a solid foam object with a reduced shrinkage, especially in the z-direction. Further, the present method allows for the formation of a foamed object without having to use a mould with walls, which implies that very large objects can be produced with this method, such as boards or planks for use in large constructions, such as buildings, and other large structures.

The size of the solid foam object to be produced may depend on the number of individual discrete units that can be placed in the first and optionally further depositions and the distance between them. The present method allows for the manufacturing of foamed planks that are at least 60*60 cm, or at least 100*100 cm, or at least 200*200 cm, or at least 300*300 cm, or at least 400*400 cm. The thickness of the foamed plank may be in the range of from 1 to 20 cm, or from 1 to 10 cm, or from 1 to 5 cm. In one example, the foamed plank has a thickness of 5 cm. The thickness of the foam plank corresponds to the height of the deposited foam. The number of deposited discrete units depends on the size of the foamed plank to be produced, the size and spacing of the discrete units as well as on the deposition method. For example, a 100*100 cm foam plank may comprise at least 100 individual discrete units. With the multi-step deposition method according to the present invention foamed objects can be produced with reduced shrinkage compared to similar foamed objects obtained with a single-step deposition. The present method also allows for a process with continuous formation of a foamed object, such as a continuously foamed web.

The present invention provides for a low-density cellulose foam comprising discrete units of cellulose foam, with stiffer densified cellulose fibre walls, embedded in a cellulose foam matrix. The incorporation of the discrete units as structural elements in solid foams, enables the formation of stiffer foams while maintaining the same low density. The discrete units constitute from 30 to 80% of the total volume, or from 40 to 80%, or from 50 to 80% of the total volume or from 60 to 80% of the total volume, or from 40 to 78% of the total volume, or from 50 to 78% of the total volume, or from 40 to 75% of the total volume, or from 50 to 75% of the total volume of the foamed material comprising the discrete units and the surrounding foam matrix. In one embodiment, the discrete units constitute from 10 to 90% of the total volume of the foamed material comprising the discrete units and the surrounding foam matrix.

In one embodiment, the density of the discrete units of foam is higher than the density of the foam matrix. For example, the density of the discrete units in the solid foam may be at least 110%, such as 130%, or 150% or 200%, higher than the density of the foam matrix. In one embodiment, the density of the discrete units in the solid foam may be in the range of from 105 to 500%, or 110 to 330%, or 110 to 250%, or 110 to 200%, or 150 to 330% higher than the density of the foam matrix.

When the wet foam density of the foam used for the discrete units is higher than the wet foam density of the foam used for the surrounding foam matrix, it has been found that the total drying time of the foam decreases, thus enabling a more efficient process. In addition, the higher density regions of the foam (i.e. the discrete units) will have different properties, for example stiffness, compared to the lower density regions (i.e. the foam matrix). This can be used to provide a foam with different properties in different regions.

In embodiments of the present invention where the density of the wet foam in the first deposition is higher than the density of the wet foam in the subsequent deposition, it has been found that the total drying time of the foam is influenced by the density of the wet foam in the first and subsequent depositions. If a cellulose foam with density D is desired, this can be provided by letting the foam in the first deposition as well as in the subsequent deposition have the same density that after drying achieves a solid cellulose foam with density D. Alternatively, the density D can be obtained by using a wet cellulose foam having a higher density for the first deposition and a wet cellulose foam having a lower density for the subsequent deposition, selected so that the average density of the solid cellulose foam will be equal to D after drying. The total drying time of the cellulose foam is shorter when the wet foam in the first deposition has a higher density than the wet foam in the subsequent deposition, as compared to a foam prepared using a wet foam with the same density for both the first deposition and the subsequent deposition. The drying time of the first deposition is always significantly faster than the drying time of the subsequent deposition due to a large portion of the surface of the discrete units of the first deposition being exposed to air. The drying is faster for a wet foam with a low density so by using a wet foam with a relatively lower density for the subsequent deposition, the drying time of the subsequent deposition, and thus also the total drying time of the solid cellulose foam can be reduced. Therefore, it is in some instances advantageous to use a wet foam with a high density for the first deposition, with a relatively short drying time, and a wet foam with a low density for the subsequent deposition.

The wet foams used for the depositions in the method according to the present invention may be prepared by mixing cellulose fibres and one or more thickeners in water to obtain a flowable fibre mixture, adding a surfactant mixture and agitating to obtain a wet foam. The mixture of cellulose fibres and one or more thickeners in water may form an adequately flowable non-flocculated fibre paste. The mixture can be aerated by the addition of a surfactant mixture and agitation, such as by mechanical agitation. The aeration may form fine micron-sized air bubbles separating the fibres. The micron-sized air bubbles will stabilize the foam, which contributes to the preservation of the shape during drying of the discrete units.

Since cellulose fibres are mixed in high concentrations a drainage step is not needed. This may reduce the overall time and costs for the method and prevent leakage of water-soluble substances added during manufacturing, thereby allowing higher concentrations of water-soluble additives in in the final foam.

The performance of the dry foam can be tailored by the amount of thickener used and hence the dry material fibre-fibre bonding strength. The amount of thickener may be from 4 to 24% or from 5 to 20%, as calculated per weight of solid content in the foam. The method according to the present invention allows adjustment of the stability of the wet foam with the use of thickeners and more stable surfactant combinations, enabling the provision of a free-standing cellulose foam. Further, the method allows for simple inclusion of different types of additives.

The density of the wet foam depends on how much air that is included during foaming. If a low density is desired, relatively more air should be included. If a high density is desired, relatively less air should be included. The density of the wet foam will have a direct influence on the density of the solid foam after drying. Thus, density differences between the wet foams of the first deposition and the subsequent deposition will remain also in the solid foam.

During drying of the discrete free-standing foam units, a densified layer is formed on the face of the foam of each discrete unit, which helps to preserve the shape of the discrete unit. After the free-standing discrete units of foam has been dried, new wet foam can be added to fill in the gaps between the dried discrete units (as illustrated by (iv) in FIG. 4). This allows for the creation of low-density cellulose foam divided into discrete units having stiffer densified cellulose fibre walls. By the incorporation of the densified thin layers the final foams can be made more rigid while maintaining the same light weight. Furthermore, this process provides for many units of a wet foam having a lower aspect ratio of width to height, minimizing the effect of tension buildup during drying and as a result mitigating the effect of shrinkage on the outer dimensions of the plank (FIG. 6).

A foam composition suitable for the preparation of a solid foam with the method according to the present invention is a foam that is self-standing and do not collapse. Other foams might be used for extrusion and cutting into discrete units, or for deposition between the discrete units, such as foams and cellular solid materials described in WO2016068771 A1, WO2016068787 A1, and WO2020011587 A1.

In one embodiment, a coating is applied to the outer surface of the discrete units prior to depositing the subsequent foam deposition. The coating is applied to the outer surface of the discrete units when the discrete units have been at least partially dried, so that the outer surface of the discrete units comprises a densified layer when the coating is applied. Alternatively, a coating may be applied to the outer surface of discrete units that are fully dried. A coating may also be applied to at least one outer surface of the solid foam. Thus, in one embodiment a coating is applied to at least one outer surface of the discrete units and/or the solid foam.

The coating is preferably applied in the form of a liquid coating composition, and one or several coating layers can be applied. The composition of the coating layers may be the same or different. If applied on the discrete units, the coating is preferably dried prior to depositing the subsequent foam deposition. The coating may comprise at least one particulate material and at least one film-forming material. The particulate material may be selected from at least one of microfibrillated cellulose (MFC), cellulose fibres or mineral particles such as clay or calcium carbonate. MFC shall in the context of the present application mean a cellulose particle, fibre or fibril having a width or diameter of from 20 nm to 1000 nm. The film-forming material may be selected from at least one of carboxymethyl cellulose (CMC), cellulose ethers, starch, polyvinyl alcohol or synthetic latexes, such as acrylic or styrene-butadiene latexes. The coating may comprise at least one hydrophobic agent, for example selected from at least one of a wax, such as bee's wax or carnauba, alkyl ketene dimer (AKD) or alkyl succinic anhydride (ASA).

By application of a coating, the air permeability of the foam decreases since pores on the surface of the foam are closed by the coating. This facilitates various processing and converting operations involving vacuum. In addition, and depending on the type of coating, properties such as strength and hydrophobicity of the foam may be altered by application of a coating. The coating is preferably applied to a surface comprising a densified layer.

In one embodiment, a coating composition comprising MFC is applied to an outer surface of the at least partially dried discrete units, and a coating composition comprising a hydrophobic agent is applied to an outer surface of the solid foam comprising discrete units embedded in a foam matrix, i.e. after the subsequent deposition step and drying step.

The coating composition may be applied using any suitable method used for coating such as roller coating, blade/knife coating, brushing, flexo roller, and spray coating.

In another aspect, the present invention relates to a solid foam comprising discrete units of a foam, and a foam matrix surrounding said discrete units. Each discrete unit may be surrounded by a densified layer of the foam. The total solid foam, as well as the discrete units and the foam matrix may comprise from 75 to 95 wt %, or from 80 to 95 wt %, or from 85 to 92 wt % or from or from 85 to 90 wt % cellulose fibres as calculated on the total weight of the dry foam. The height of the discrete units may be from 90 to 100%, or from 95 to 100%, or from 98 to 100%, or equal to the height of the total solid foam prepared. In one embodiment, the height of the discrete units may be from 70 to 100%, or from 70 to 95%, or from 75 to 90%, of the height of the total solid foam prepared. The solid foam may have a density of 10-60 kg/m³, or from 20-50 kg/m³. In one embodiment, the solid foam may have a density of 10-80 kg/m³.

The density and properties of the final solid foam can be adjusted by using discrete units with the same or different densities as the foam matrix. The discrete units may also have densities that may differ from each other to provide the solid foam with different densities at different locations. The density of the discrete units in the solid foam may be from 83% to 500%, or from 60% to 150%, or from 90% to 110% of the density of the foam matrix surrounding said discrete units. Preferably, the discrete units have a density that is from 90% to 110% of the density of the foam matrix surrounding said discrete units.

In one embodiment, the density of the discrete units of foam is higher than the density of the foam matrix. For example, the density of the discrete units in the solid cellulose foam may be at least 110%, such as 130%, or 150% or 200%, higher than the density of the cellulose foam matrix. In one embodiment, the density of the discrete units in the solid cellulose foam may be in the range of from 105 to 500%, or 110 to 330%, or 110 to 250%, or 110 to 200%, or 150 to 330% higher than the density of the cellulose foam matrix.

Each discrete unit may have a three-dimensional shape, such as a cylinder or a polyhedron. Examples of symmetric polyhedrons are cubes, cuboids (such as rectangular cuboids), and hexagonal prisms. Small variations in symmetry of the discrete units may exist without changing their main purpose to impart stability to the foam. In some embodiments, each discrete unit has the form of a cylinder. The diameter, or width, of the discrete unit may be from 0.5 to 3 times its height, or from 0.5 to 2, or from 0.5 to 1.5, or from 0.8 to 3, or from 0.8 to 2, or from 0.8 to 1.5, or from 1 to 3, or from 1 to 2, or from 1 to 1.5 times its height.

In one embodiment, the width of each discrete unit is less than 1.3 times its height, such as less than 1.2, or from 0.5 to 1.3, or from 0.5 to 1.2, or from 0.7 to 1.3, or from 0.7 to 1.2, or from 0.9 to 1.3, or from 0.9 to 1.2 times its height. The drying time of the foam in the discrete units is shortened when the width of each discrete units is less than 1.3 times its height, and thus the total drying time of the foam will also be shortened. The width of the discrete units in the foam may also differ from each other in order to provide a solid foam with different properties at different locations. However, the width of each discrete unit in the foam is still preferably less than 1.3 times its width.

In some embodiments, the width of the discrete units is larger at the bottom part of the discrete units than at the top part. For example, the discrete units may have the shape of a cone, a truncated cone, a pyramid, or a truncated pyramid. In such embodiments, the bottom parts of adjacent discrete units may be partly in contact. The contact may be along the entire perimeter, or along parts of the perimeter, of the bottom parts of the discrete units. For the remaining height, i.e. the part of the height of the discrete unit located above the bottom part, the discrete units are separated from each other, i.e. not in contact. For example, a discrete unit may be partly in contact with one or several adjacent discrete units along less than 30%, or less than 20%, or less than 10%, or less than 5%, of the height of a discrete unit, as measured perpendicular from the surface on which the discrete unit has been deposited. The discrete units are visibly distinguishable from each other in the solid foam.

In one embodiment, at least one outer surface of the discrete units and/or the solid foam has been provided with a coating. The presence of a coating may influence properties such as strength, hydrophobicity, air permeability and surface gloss of the solid foam.

In a further aspect, the present invention relates to a solid foam prepared by the method according to the present invention. A foam according to the present invention may be used in large sheets.

The invention will now be described by the following examples which do not limit the invention in any respect. All cited documents and references mentioned herein are incorporated by reference in their entireties.

### EXAMPLES

### Example 1

### Multi-Step Deposition

For a first deposition of wet foam in discrete units, a uniform wet paste was prepared comprising 12 wt % cellulose pulp in water and a thickener. The paste was aerated with a surfactant mixture until a wet foam density of 222 kg/m³ was obtained.

Cylindric moulds with the dimensions of 5 cm in height and 6.6 cm in diameter were used to deposit 12 discrete units of the foam on a flat surface (oven tray with a frame with dimensions of 27*37*5 cm). The moulds were used only for depositing the foam in the desired shape and dimension and are removed before drying. The discrete units were dried in an ordinary convection oven at 120° C. for 1-2 hours.

For the second deposition, a new batch of wet foam was prepared following the above description for the wet foam used in the first deposition. The wet foam was filled in the space between the discrete units, leaving out no voids in the oven frame. The surface was scraped to remove any possible extra foam and levelling out the surface to the height of the frame. Finally, the foam was dried in the oven at 120° C. for 8 hours.

The density of the dried discrete units as well as the density of the final foam object was ˜30-31 kg/m³. The final thickness of the foam object was ˜5 cm and no shrinkage was observed.

### Example 2 (Comparative Example)

### Single-Step Deposition

A uniform wet paste comprising 12 wt % cellulose pulp in water and a thickener was prepared. The paste was aerated with a surfactant mixture until a wet foam density of 222 kg/m³ was obtained.

A mould of 27*37*5 cm was filled with the aerated wet foam and the surface was scraped to remove any possible extra foam and levelling out the surface to the height of the frame. Finally, the foam is dried in an ordinary convection oven at 120° C. for 8 hours.

The density of the dried foam object was ˜30 kg/m³ and a shrinkage of 20% was observed in the centre of the foam object. The shrinkage is calculated based on the difference of the thickness in the centre of the foam and near the edges of the foam.

### Example 3

### Preparation of a Foam Object

A uniform wet paste comprising 12 wt % cellulose pulp in water and a thickener was prepared. A surfactant mixture was added to the paste and the obtained mixture was extruded and simultaneously aerated to obtain an extruded wet foam with a density of 222 kg/m³. The extruded foam was dried to obtain a foam object. The foam object was cut into square pieces of 4*4 cm and a height of ˜5 cm. The square pieces were distributed throughout a 27*37*5 mould. The mould was filled with wet foam prepared according to the description in example 1. The surface was scraped afterwards to remove any possible extra foam and levelling out to the height of the frame. The foam object was then dried in an ordinary convection oven at 120° C. for 8 hours.

The density of the dried cut discrete units as well as the density of the final foam was ˜30-31 kg/m³. The final thickness of the foam object was ˜5 cm and no shrinkage was observed.

### Experimental Methods, Examples 1-3

### Characterization

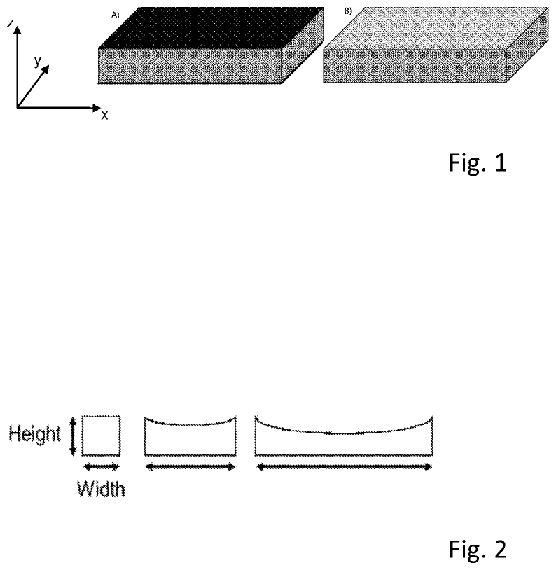

The comparative foam prepared according to Example 2 presents a densification on the top, bottom and side faces of the sheet (as illustrated in FIG. 1A), while the core of the foam sheet is a homogeneous fibre network of lower density (FIG. 1B).

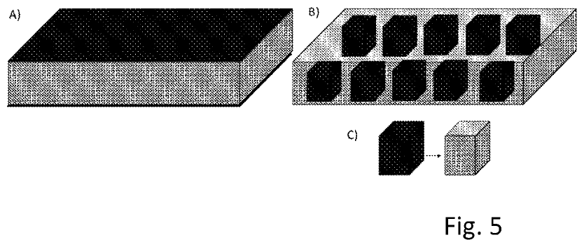

The foam produced according to Example 1 also presents a densification on the top, bottom and side faces of the sheet (as illustrated in FIG. 5A) while the bulk of the material contains discrete units of foam that are distinguished from the foam matrix by border walls of densified cellulose fibre material (FIG. 5B).

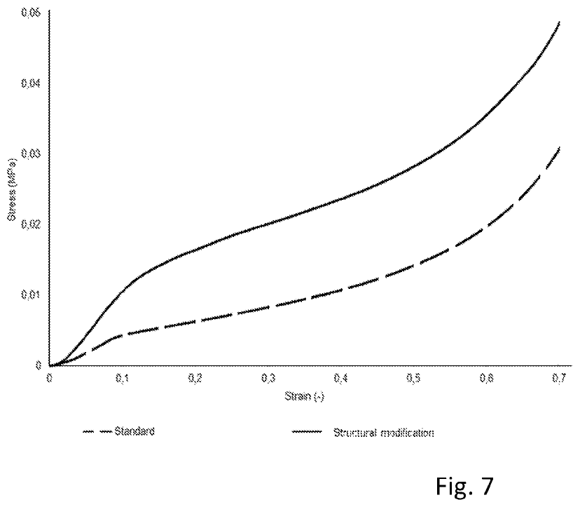

Compression curves were obtained for the multistep deposition foam according to Example 1, and the single-step deposition foam prepared according to Example 2 (FIG. 7). Dried solid foams were cut into 10 cm square test pieces with heights of 5 cm. Compression tests were performed with an Instron 5969 universal testing machine in a conditioned room at 23° C. and 50% relative humidity. The samples were conditioned at 23° C. and 50% relative humidity for 48 hours prior being tested. A 500 N load cell, 15 cm in diameter, was used with a compression rate of 100% of the original sample thickness per min. The final strain was chosen to 70% of the original specimen height. The multistep deposition foam provides for an improved energy absorption as is demonstrated by the larger area under the solid curve compared with the area under the dashed curve obtained for the single-step deposition foam.

### Example 4

### Width to Height Ratio of Discrete Units

A uniform wet paste comprising 12 wt % cellulose pulp in water and a thickener was prepared. The paste was aerated with a surfactant mixture until a wet foam density of 208 kg/m³ was obtained. The foam was filled in a frame on a perforated tray and the surface was scraped to remove any possible extra foam and levelling out the surface to the height of the frame. The foams were prepared in the height of 2.1 cm using a frame that sets the height. From the foam wet foam squares were cut out and removed to leave a pattern of deposited material in a precise squared pattern with every second square not filled, as filling out only the white squares of a chess board. The square widths used were 2.5 cm, 5 cm and 10 cm. The frames were sufficiently large to allow a few repetitions of the pattern 43*24.5 cm.

The wet foam in example 4 was used for a drying study in which three scenarios were tested:
(1) To dry the material that was deposited as divided in uniform squares.
(2) to fill up with new foam in each void between the squares, scrape the surface again and dry the second deposition.
(3) to fill the whole frame with one single deposition, scrape it, and dry it (comparative).

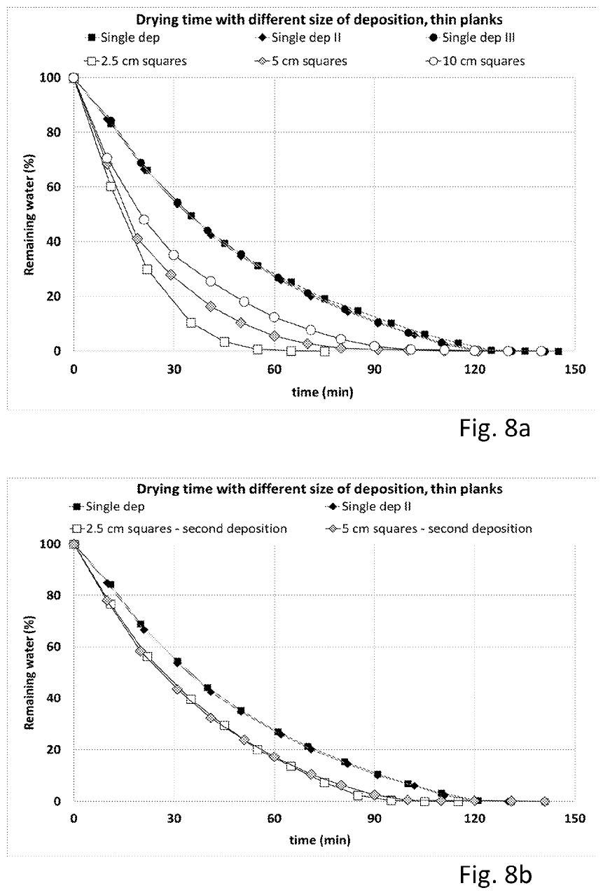

The foams were weighted while drying in regular intervals and plotted as drying curves. These drying curves are found in FIG. 8a-b. From FIG. 8a it is clear that the drying time decreases when the width of the discrete unit is decreased. This is due to the smaller volume of the discrete unit. It is also evident that the drying time for a single-step deposition is significantly longer. From FIG. 8b it is clear that also the drying time for the subsequent foam deposition surrounding the discrete units is faster than the drying time for a single-step deposition. Thus, the total drying time, i.e. the combined drying time for the first and subsequent foam depositions, is shorter when discrete units having a width that is less than 1.3 times its height are used, as compared to a single-step deposition.

### Example 5

### Density of Foam in Discrete Units and Foam Matrix

A uniform wet paste comprising 12 wt % cellulose pulp in water and a thickener was prepared. The paste was aerated with a surfactant mixture until a desired wet foam density was obtained. Wet foams of different densities (see table 1) were prepared. Cylindric moulds with the dimensions of 5 cm in height and 6.6 cm or 9.2 cm in diameter were used to deposit four discrete units of the foam on a flat surface (oven tray with a frame with dimensions of 20*20*5 cm). Four depositions with 6.6 cm diameter moulds covers approximately ⅓ of the frame volume, while 9.2 cm diameter moulds cover ⅔ of the frame volume. The moulds were placed in a symmetric fashion with equal distance between each mould and to the frame wall. The moulds were used only for depositing the foam in the desired shape and dimension and were removed before drying. The discrete units were dried in an ordinary convection oven at 120° C. until completely dry. When the first deposited discrete units were dry and had cooled down to room temperature for an extended time, a second deposition was applied filling up the void in between the discrete units. The frame was completely filled, scraped and dried in oven at 120° C. until completely dry. The foam in the second deposition typically had a different density than the foam in the first deposition. The aim was to reach approximately similar end density of the dry material and therefore wet foam densities were used to always put approximately the same total amount of material in the frame. The wet foam densities that were used are described in table 1.

TABLE 1

| Share of total frame volume | Density in | Density in |
|---|---|---|
| deposited in first step | first deposition | second deposition |
| (6.6 or 9.2 cm diameter mould) | (kg/m³) | (kg/m³) |
| ⅓ | 84 | 268 |
| ⅓ | 116 | 248 |
| ⅓ | 208 | 208 |
| ⅓ | 312 | 152 |
| ⅓ | 384 | 116 |
| ⅔ | 268 | 84 |
| ⅔ | 248 | 116 |
| ⅔ | 208 | 208 |
| ⅔ | 152 | 312 |
| ⅔ | 116 | 384 |

It was found that the total drying time of the foam within the frame was shorter when the foam in the first deposition had a higher density than the foam in the second deposition.

Sample pieces were also made with the same frames 20×20×5 cm with single step deposited foam. These pieces were used as reference material to compare the cushioning properties of two step deposited material with single step deposited material. These test pieces were fabricated in a range of densities.

The sample pieces were conditioned in 23° C. and 50% RH (relative humidity) for 3 days and used as sample pieces for drop testing.

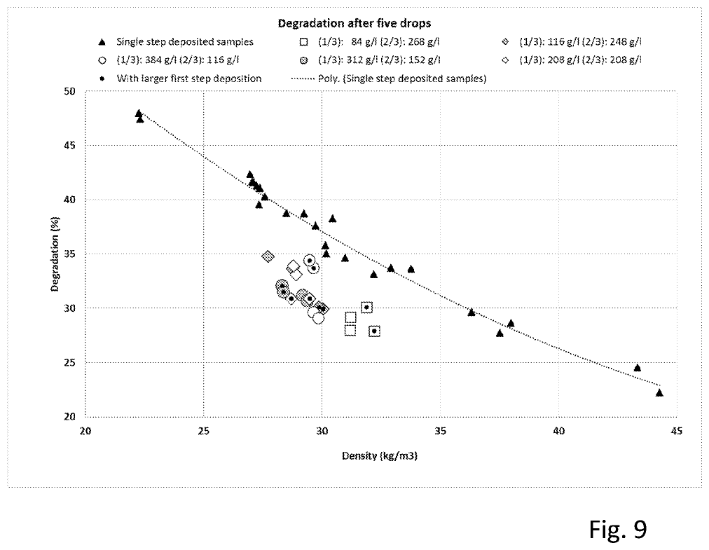

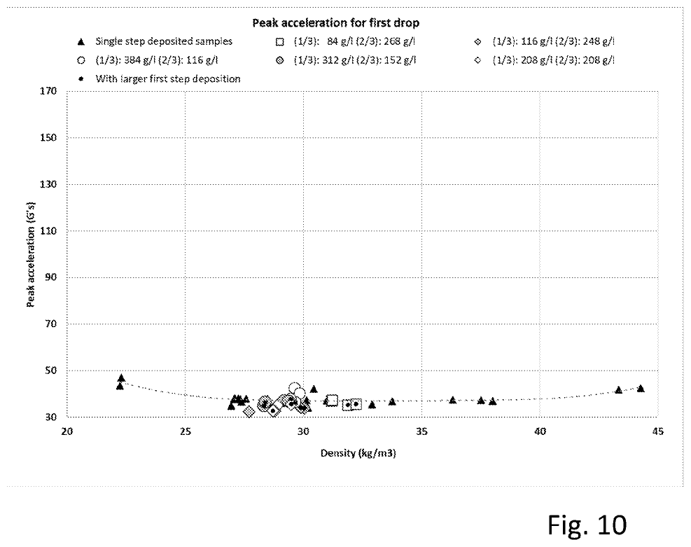

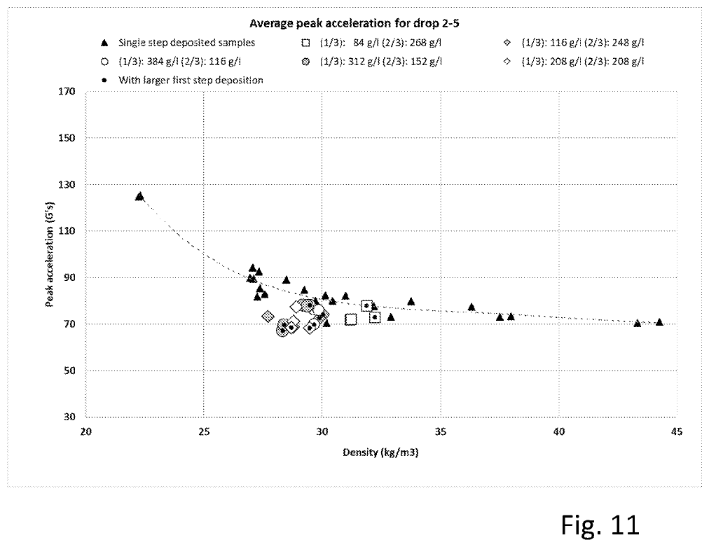

The results of the drop testing, degradation and peak acceleration as function of sample density, is found in FIG. 9 (degradation), FIG. 10 (peak acceleration for drop 1) and FIG. 11 (peak acceleration for drop 2-5). The different foams used in the tests are further explained in table 1. To illustrate the symbols used, (a) in the figure represents a cellulose foam formed from a first deposition of a foam having a density of 84 kg/m³ deposited in discrete units with a diameter of 6.6 cm, and a second deposition of a foam having a density of 268 kg/m³. Dotted symbols are the reverse, for the same example the dotted white square represents a cellulose foam formed from a first deposition of a foam having a density of 268 kg/m³ deposited in discrete units with a diameter of 9.2 cm, and a second deposition of a foam having a density of 84 kg/m³.

### Experimental Methods, Example 5

Drop test data was generated using a “TrueDrop-160” free fall drop tester in which a 20×20×5 cm piece of the sample material is tested. The material is placed in the bottom of a corrugated box with supporting PE-foam on the sides to hold it in place in horizontal direction. On top of the sample material a metal weight of 4.8 kg is placed. The metal weight has a 20×20 cm bottom side, and thus distribute a load of 12 g/cm² on the sample. The metal weight is also held in place in the horizontal direction by the supporting PE foam. On top of the metal weight an accelerometer that records the acceleration while performing drop tests is placed. When a drop test is performed, the box containing the sample and the metal weight is dropped in straight vertical direction and allowed a free fall of 76 cm before hitting a metal floor. This is performed five times per sample and two results are registered:
1: Peak acceleration: Which is the maximum acceleration that the accelerometer placed on the metal weight is registering. The high acceleration occurs after the impact when the sample material is using its cushioning ability to break the fall of the metal weight. A low peak acceleration is considered a positive result for a cushioning material such as the cellulose foam according to the present invention.
2: Degradation: Which is the difference between starting height of the sample pieces before dropping and its height after 5 consecutive drops. The height was measured with a caliper measuring in five positions, one on each side and one in the centre to calculate the average height.

$$Degradation = 1 - ( \text{height after 5 drops/Starting height} ) .$$

For a piece that has a first height of 5 cm and a height of 4 cm after five consecutive drops, the degradation is then: 1−(4/5)=20%

The sample pieces were conditioned in 23° C. and 50% RH (relative humidity) for 3 days before any measurements were performed on them.

The results (FIGS. 9-11) show that the cellulose foam produced using a two-step deposition method has a better cushioning performance than a cellulose foam produced from a single-step deposition. The foams produced using a two-step deposition method according to the present invention, behaves similarly to cellulose foams produced with a lower density in the first deposition compared to the second deposition, or foams produced with similar density in both depositions. This proves that the decrease in drying time does not have an impact on the cushioning performance of the cellulose foam.

All combinations of different densities for first and second deposition performed better than single step deposited cellulose foam when it came to reducing degradation (relative compression after 5 drops). All combinations of different densities for first and second deposition also performed similar to single step deposited planks for peak acceleration of first drop and reduced the peak acceleration for the average of drop 2-5 compared single step deposited material for drop 2-5. These comparative statements refer to comparing materials with similar density.

### Example 6

### Preparation of a Foam Plank

A composition comprising 14% pulp, 1.6% CMC and 0.08% surfactant, all amounts based on the total weight of the composition, in water was foamed to a wet foam, using mechanical agitation. The wet foam had a final density of 182 kg/m³ and a final dry content of 15.7%. A first deposition of foam was deposited using a depositor that can dispense the foam as discrete units onto a flat metal tray. Discrete units of foam were deposited in a pyramidal geometry. The discrete units were deposited in rows along the tray, they were placed 75 mm distance apart in the width direction and 37.5 mm in the length direction (with a 45° offset between rows). By regulating the output pressure of the depositor and the distance to the tray, the flow profile of the foam in the discrete units was tailored to flow outwards on the tray or to build height. A high pressure was applied during deposition so that the foam at the bottom part of each discrete unit started to flow and spread out so that it came into contact with its neighboring discrete units. After the first deposition, the wet foam was dried at 80° C. using a convection dryer until the foam was completely dry. The discrete units were distinguishable from each other after drying also at places of contact between neighboring discrete units. No mixing was observed at places of contact. After the first drying step, the voids between the dried discrete units were filled with wet foam having the same composition as used for the discrete units. The same depositor was used, and the pressure was regulated so that all the gaps in between the discrete units were filled so that a wet foam plank was formed. Subsequently, the surface of the deposited wet foam plank was scraped in order to give the plank a flat surface. The size of the foam plank was 80*120 cm. The thickness of the foam plank was 5 cm, as measured from the tray. Subsequent drying was conducted using a convection dryer at 80° C. until the foam plank was completely dry.

1. A method for preparing a solid foam, wherein the method comprises:
depositing discrete units of a foam on a surface to obtain a first foam deposition,
depositing a wet foam between the discrete units to obtain a subsequent foam deposition, and
drying the wet foam to obtain a solid foam wherein the discrete units of a foam are embedded in a foam matrix.

2. The method according to claim 1, wherein a height of the discrete units is between 70 to 100% of a height of the wet foam in the subsequent foam deposition.

3. The method according to claim 1, wherein the wet foam in the subsequent foam deposition comprises at least 10 wt % cellulose, as calculated on a total weight of the wet foam.

4. The method according to claim 1, wherein the discrete units are obtained by dispensing a wet foam as discrete units on to a surface, followed by drying of the wet foam.

5. The method according to claim 1, wherein the discrete units are obtained by extruding a wet foam, drying the wet foam to form a dried foam, cutting the dried foam into the discrete units, and depositing said discrete units on to a surface.

6. The method according to claim 4, wherein the wet foam used to obtained the discrete units comprises at least 10 wt % cellulose, as calculated on a total weight of the wet foam.

7. The method according to claim 1, wherein the wet foam has a density from 70-600 kg/m³.

8. The method according to claim 1, wherein the solid foam comprises 75-95 wt % cellulose fibres, as calculated on a total weight of the solid foam.

9. The method according to claim 1, wherein the solid foam has a density of 10-60 kg/m³.

10. The method according to claim 1, wherein a density of the foam of the discrete units is higher than a density of the foam matrix.

11. The method according to claim 1, wherein a width of each discrete unit is less than 1.3 times a height of the discrete unit.

12. The method according to claim 1, wherein a coating is applied to at least one outer surface of the discrete units, or the solid foam, or both.

13. A solid foam comprising:
discrete units of a foam embedded in a foam matrix, and
wherein the solid foam comprises at least 75-95 wt % cellulose fibres as calculated on a total weight of the solid foam.

14. The solid foam according to claim 13, wherein a height of the discrete units is from 70 to 100% of a height of the foam matrix.

15. The solid foam according to claim 13, wherein the solid foam has a density of 10-60 kg/m³.

16. The solid foam according to claim 13, wherein each discrete unit is surrounded by a densified layer of foam.

17. A solid foam according to claim 13, wherein a density of the foam of the discrete units is higher than a density of the foam matrix.

18. The solid foam according to claim 13, wherein a width of each discrete unit is less than 1.3 times a height of the discrete unit.

19. The solid foam according to claim 13, wherein an outer surface of the discrete units, or the solid foam, or both has been provided with a coating.

20. A solid foam prepared by the method according to claim 1.

21. (canceled)
